(19) United States
(12) Patent Application Publication
(10) Pub. No.: US 2021/0364954 A1
(43) Pub. Date: Nov. 25, 2021

(54) FIXING MEMBER FOR ELECTROPHOTOGRAPHIC DEVICE

(71) Applicant: Sumitomo Riko Company Limited, Aichi (JP)

(72) Inventors: Kazunori TAKAKI, Aichi (JP); Hirotoshi MATSUDA, Aichi (JP); Daiki ITO, Aichi (JP); Yasuhide WATANABE, Aichi (JP); Isamu MARUYAMA, Aichi (JP); Shingo NAKAICHI, Aichi (JP); Yasuyuki HAYASAKI, Aichi (JP)

(73) Assignee: Sumitomo Riko Company Limited, Aichi (JP)

(21) Appl. No.: 17/396,772

(22) Filed: Aug. 9, 2021

Related U.S. Application Data
(63) Continuation of application No. PCT/JP2020/020141, filed on May 21, 2020.

(30) Foreign Application Priority Data
Jun. 26, 2019 (JP) 2019-118651

(51) Int. Cl. G03G 15/20

(52) U.S. Cl. CPC G03G 15/206

(57) ABSTRACT

A fixing member 10 for an electrophotographic device includes a base layer 12, a metal layer 14 formed on the based layer 12, and a protective layer 16 formed on the metal layer 14. The metal layer 14 is configured to form a predetermined pattern. The base layer 12 has a surface 12a which is covered with the metal layer 14 and a surface 12b which is not covered with the metal layer 14. The protective layer 16 continuously covers the surface 12b of the base layer 12 not covered with the metal layer 14 and a surface of the metal layer 14, and is bonded to the surface 12b of the base layer 12 not covered with the metal layers 14. The base layer 12 and the protective layer 16 contain a resin that includes an imide bond in a repeating unit.

### CROSS-REFERENCE TO RELATED APPLICATIONS

This application is a continuation application of International Application number PCT/JP2020/020141, filed on May 21, 2020, which claims the priority benefit of Japan Patent Application No. 2019-118651 filed on Jun. 26, 2019. The entirety of each of the above-mentioned patent applications are hereby incorporated by reference herein and made a part of this specification.

### BACKGROUND

### Technical Field

The present disclosure relates to a fixing member for an electrophotographic device.

### Related Art

In an electrophotographic device such as a copier, a printer, a facsimile, or the like using an electrophotographic method, a toner image is formed on a recording medium (paper or the like), and the recording medium on which the toner image is formed is heated, pressurized and fixed by a heating member (fixing member), thereby forming an image. The heating member (fixing member) has a metal layer serving as a heat-generating layer. In order to improve durability of the metal layer, as described in Patent literature 1, it is proposed that the metal layer is configured to have an uneven shape in which an outer side or inner side surface of the metal layer is a curved surface with peaks and valleys. In addition, Patent literature 1 also describes that a protective layer is formed on the outer side surface of the metal layer.

### Literature of Related Art

### [Patent Literature]

Patent literature 1: Japanese Patent Laid-Open No. 2012-98586

In the fixing member of Patent literature 1, repeated bending fatigue may cause a crack or a breakage in the metal layer. In addition, repeated use may cause peeling between the metal layer and a base material. This is probably because there is a difference in the elastic modulus between a resin of the base material and the metal layer, and stress is concentrated on the metal layer having poor bendability, thus causing the metal layer to crack or break easily. In addition, this is probably because peeling easily occurs between the metal layer and the base material due to a difference between stress applied to the metal layer and stress applied to the base material.

A problem to be solved by the present disclosure is to provide a fixing member for an electrophotographic device with improved durability based on reduced bending fatigue and improved adhesion of a metal layer.

### SUMMARY

A fixing member for an electrophotographic device according to the present disclosure is as follows. The fixing member for an electrophotographic device includes: a base layer, a metal layer formed on the based layer, and a protective layer formed on the metal layer. The metal layer is configured to form a predetermined pattern. The base layer has a surface which is covered with the metal layer and a surface which is not covered with the metal layer. The protective layer continuously covers the surface of the base layer not covered with the metal layer and a surface of the metal layer, and is bonded to the surface of the base layer not covered with the metal layer. The base layer and the protective layer contain a resin that includes an imide bond in a repeating unit.

The resin that includes an imide bond in the repeating unit is preferably a polyimide resin. The thickness of the metal layer is preferably within a range of 1.0 to 10 μm. The area ratio of the surfaces to which the protective layer is bonded with respect to the entire surface of the base layer is preferably within a range of 20 to 75%. The thickness of the protective layer on the metal layers is preferably within a range of 10 to 50 μm.

### BRIEF DESCRIPTION OF THE DRAWINGS

FIG. 1 is an external schematic diagram of a fixing member for an electrophotographic device according to one embodiment of the present disclosure.

FIG. 2 are schematic diagrams in which (a) of FIG. 2 is a cross-sectional view taken along an A-A line of the fixing member for an electrophotographic device of FIG. 1, and (b) of FIG. 2 is a part of a cross-section taken along a B-B line of the fixing member for an electrophotographic device of FIG. 1.

FIG. 3 is a manufacturing process diagram of the fixing member for an electrophotographic device according to one embodiment of the present disclosure.

FIG. 4 is a part of an axial cross-section of a fixing member for an electrophotographic device according to another embodiment of the present disclosure.

FIG. 5 is a schematic diagram describing a method for evaluating durability of a fixing member.

### DESCRIPTION OF THE EMBODIMENTS

According to the fixing member for an electrophotographic device according to the present disclosure, the protective layer continuously covers the surface of the base layer not covered with the metal layer and a surface of the metal layer, and the metal layer is embedded between the base layer and the protective layer, and thus stress concentration on the metal layer is reduced, the generation of crack or breakage in the metal layer due to repeated bending fatigue is suppressed, and bending fatigue of the metal layer is reduced. In addition, the base layer and the protective layer respectively contain a resin that contains an imide bond in a repeating unit, and the protective layer is bonded to the base layer by the surface of the base layer not covered with the metal layer, and thus peeling between the metal layer and the base layer due to repeated use is suppressed. Accordingly, durability is improved based on the reduced bending fatigue and improved adhesion of the metal layers.

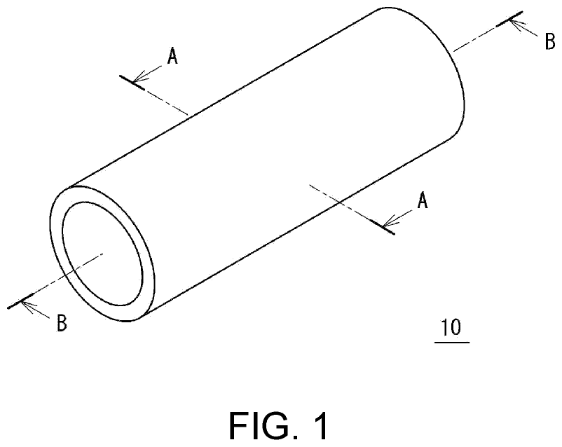

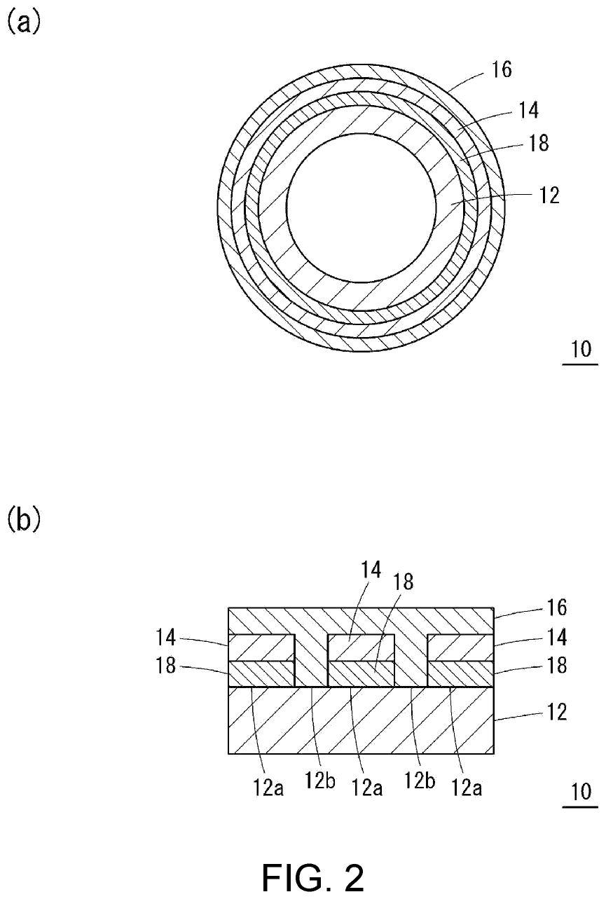

FIG. 1 is an external schematic diagram of a fixing member for an electrophotographic device according to one embodiment of the present disclosure. In FIG. 2, (a) of FIG. 2 is a cross-sectional view taken along an A-A line of the fixing member for an electrophotographic device of FIG. 1, and (b) of FIG. 2 is a part of a cross-section taken along a B-B line of the fixing member for an electrophotographic device of FIG. 1.

As shown in FIG. 1, a fixing member 10 for an electrophotographic device (hereinafter, sometimes simply referred to as the fixing member 10) according to one embodiment of the present disclosure is formed in a cylindrical shape and has a seamless structure having no joint in a circumferential direction. Besides, as shown in (a) of FIG. 2 and (b) of FIG. 2, the fixing member 10 includes: a base layer 12, metal layers 14 formed on the base layer 12, and a protective layer 16 formed on the metal layers 14. The fixing member 10 is used as a heating member (fixing member) in a fixing process of an electrophotographic device. The fixing member 10 is shown as a fixing belt formed in a cylindrical shape, but the fixing member according to the present disclosure may be a fixing roll formed in a roll shape on the outer periphery of a shaft body.

The base layer 12 is the base of the fixing member 10. The base layer 12 is formed in a cylindrical shape and has a seamless structure having no joint in the circumferential direction. The base layer 12 is configured by a material containing an organic polymer. The organic polymer which constitutes the base layer 12 is preferably an organic polymer having excellent heat resistance. From the viewpoint of heat resistance, strength, and the like, the organic polymer which constitutes the base layer 12 is set to a resin that includes an imide bond in a repeating unit. The resin that includes an imide bond in a repeating unit may be a polyimide resin or a polyamide-imide resin. The polyimide resin and the polyamide-imide resin may be a modified polyimide resin and a modified polyamide-imide resin.

An additive or the like may be contained in the base layer 12. The additive may be a mold release agent, a flame retarder, a filling agent, a leveling agent, an antifoaming agent, and the like.

The thickness of the base layer 12 is not particularly limited, but from the viewpoint of durability, manufacturability, and the like, the thickness of the base layer 12 is preferably within a range of 20 to 200 μm. The thickness of the base layer 12 is more preferably within a range of 25 to 140 μm, and further preferably within a range of 30 to 80 μm.

The metal layer 14 is a part that generates heat during energization. According to a heat-generating principle of induction heating using an IH coil, when an alternating current is supplied to the IH coil disposed in the vicinity of the fixing member 10, a magnetic field is induced, an eddy current is generated in the metal layer 14 of the fixing member 10 due to the magnetic field, and the metal layer 14 generates heat. As shown in (a) of FIG. 2, the metal layer 14 extends along the circumferential direction of the fixing member 10 having a cylindrical shape and forms a ring shape in the circumferential direction. As shown in (b) of FIG. 2, a plurality of the metal layers 14 having a ring shape in the circumferential direction are disposed at predetermined intervals in an axial direction of the fixing member 10 having a cylindrical shape. The plurality of metal layers 14 are respectively configured by metal lines with equal width and equal thickness. A predetermined pattern is formed by the repeating structure. Moreover, the pattern shape of the metal layers 14 is not particularly limited. The pattern of the metal layers 14 may form a ring shape in the circumferential direction of the fixing member 10 as shown in (a) of FIG. 2 and (b) of FIG. 2, or may extend along the axial direction. In addition, the pattern of the metal layers 14 may have a spiral shape in the axial direction. The fixing member 10 is configured so as to uniformly generate heat on the outer peripheral surface thereof, and is configured so that temperature irregularity does not occur. As described later, the metal layers 14 (metal lines) are formed by plating. This kind of fixing member has high heat transfer efficiency, and the surface temperature of the fixing member can be rapidly increased to a predetermined temperature after the energization of a resistance heater is started, and the start-up is fast.

The metal layers 14 are configured to form a predetermined pattern, and thus the base layer 12 has surfaces 12a covered with the metal layers 14 and surfaces 12b not covered with the metal layers 14.

A metal which constitutes the metal layers 14 may be Cu, Ni, Ag, Pd, Sn, Au, an alloy of one or more types of these metals, and the like.

The thickness of the metal layer 14 is not particularly limited, but from the viewpoint of heat-generating properties, durability, and the like, the thickness of the metal layer 14 is preferably 1.0 μm or more. The thickness of the metal layer 14 is more preferably 2.0 μm or more, and further preferably 3.0 μm or more. In addition, from the viewpoint of durability and the like, the thickness of the metal layer 14 is preferably 10 μm or less. The thickness of the metal layer 14 is more preferably 8.0 μm or less, and further preferably 7.0 μm or less.

From the viewpoint of manufacturability, heat-generating properties, and the like, the width of the metal layer 14 is preferably 0.1 mm or more. The width of the metal layer 14 is more preferably 0.2 mm or more. In addition, from the viewpoint of, for example, easily reducing temperature irregularity, the width of the metal layer 14 is preferably 0.5 mm or less. The width of the metal layer 14 is more preferably 0.4 mm or less.

From the viewpoint of improvement of manufacturability and heat-generating properties and the like, the interval of the metal layers 14 is preferably 0.1 mm or more. The interval of the metal layers 14 is more preferably 0.15 mm or more. In addition, from the viewpoint of, for example, easily reducing temperature irregularity, the interval of the metal layers 14 is preferably 0.3 mm or less. The interval of the metal layers 14 is more preferably 0.25 mm or less.

The protective layer 16 protects surfaces of the metal layers 14. The surfaces of the metal layers 14 refer to surfaces which are disposed on the radial outer side of the fixing member 10. The protective layer 16 is formed on the metal layers 14 and covers the surfaces of the metal layers 14. The protective layer 16 is formed not only on the metal layers 14 but also on the surfaces of the base layer 12 between the metal layers 14 which are not covered with the metal layers 14, and also covers the surfaces 12b of the base layer 12 not covered with the metal layers 14. The surfaces 12b of the base layer 12 not covered with the metal layers 14 refer to surfaces not covered with the metal layers 14 in the surface of the base layer 12 disposed on the radial outer side of the fixing member 10. Accordingly, the protective layer 16 continuously covers the surfaces 12b of the base layer 12 not covered with the metal layers 14 and the surfaces of the metal layers 14, and the metal layers 14 are embedded between the base layer 12 and the protective layer 16. The protective layer 16 is in contact with the surfaces 12b of the base layer 12 not covered with the metal layers 14, and similar to the base layer 12, contains a resin that includes an imide bond in a repeating unit, and thus the protective layer 16 is bonded to the surfaces 12b of the base layer 12 not covered with the metal layers 14. Moreover, the resin that includes an imide bond in a repeating unit is a resin listed in the base layer 12.

The protective layer 16 continuously covers the surfaces 12b of the base layer 12 not covered with the metal layers 14 and the surfaces of the metal layers 14, and the metal layers 14 are embedded between the base layer 12 and the protective layer 16, and thus stress concentration on the metal layers 14 is reduced, the generation of crack or breakage in the metal layers 14 due to repeated bending fatigue is suppressed, and the bending fatigue of the metal layers 14 is reduced. In addition, the base layer 12 and the protective layer 16 respectively contain a resin that includes an imide bond in a repeating unit, and the protective layer 16 is bonded to the base layer 12 by the surfaces 12b of the base layer 12 not covered with the metal layers 14, and thus peeling between the metal layers 14 and the base layer 12 due to repeated use is suppressed. Accordingly, durability is improved based on the reduced bending fatigue and improved adhesion of the metal layers 14. Besides, the protective layer 16 is formed on the metal layers 14, and thereby surface unevenness resulted from the metal layers 14 is smoothed, and the surface of the fixing member 10 becomes smooth. Thus, the contact surface with a printed matter becomes uniform.

The combination of a resin that includes an imide bond in a repeating unit which is contained in the base layer 12 and a resin that includes an imide bond in a repeating unit which is contained in the protective layer 16 may be: a combination in which the former is a polyimide resin and the latter is a polyimide-imide resin; a combination in which the former is a polyimide-imide resin and the latter is a polyimide resin; a combination in which both the former and the latter are polyimide resins; a combination in which both the former and the latter are polyimide-imide resins; and the like. Among these combinations, the combination in which both the former and the latter are polyimide resins is preferable from the viewpoint of durability, strength, and the like.

A heat-conductive filler may be contained in the protective layer 16. When the heat-conductive filler is contained in the protective layer 16, heat conductivity of the protective layer 16 is improved, and heat generated in the metal layers 14 is efficiently transmitted to the outer peripheral surface of the fixing member 10. An additive or the like may be contained in the protective layer 16. The additive may be a mold release agent, a flame retarder, a filling agent, a leveling agent, an antifoaming agent, and the like.

From the viewpoint of durability, adhesion of the metal layers 14, and the like, the thickness of the protective layer 16 on the metal layers 14 is preferably 10 μm or more. The thickness of the protective layer 16 on the metal layers 14 is more preferably 15 μm or more. In addition, from the viewpoint of heat-generating properties and the like, the thickness of the protective layer 16 on the metal layers 14 is preferably 50 μm or less. The thickness of the protective layer 16 on the metal layers 14 is more preferably 40 μm or less, and further preferably 30 μm or less.

From the viewpoint of adhesion of the metal layers 14 and the like, the area ratio of the surfaces to which the protective layer 16 is bonded with respect to the entire surface of the base layer 12 is preferably 20% or more. The area ratio of the surfaces to which the protective layer 16 is bonded with respect to the entire surface of the base layer 12 is more preferably 30% or more. In addition, from the viewpoint of, for example, suppressing a decrease in heat-generating properties resulted from a decrease in the area ratio of the metal layers 14 and suppressing a decrease in durability, the area ratio of the surfaces to which the protective layer 16 is bonded with respect to the entire surface of the base layer 12 is preferably 75% or less. The area ratio of the surfaces to which the protective layer 16 is bonded with respect to the entire surface of the base layer 12 is more preferably 70% or less, and further preferably 60% or less. The entire surface of the base layer 12 refers to the entire outer peripheral surface of the base layer 12.

Plating foundation layers 18 under the metal layers 14 and on the base layer 12. The plating foundation layers 18 are the foundation for forming the metal layers 14 by plating. Similar to the metal layers 14, the plating foundation layers 18 are configured to form a predetermined pattern. The plating foundation layers 18 at least include a plating catalyst necessary for plating. The plating foundation layers 18 are respectively in contact with the metal layers 14 and the base layer 12. The plating foundation layers 18 have widths equal to those of the metal layers 14, and are formed in the same pattern shape as the metal layers 14.

For example, the fixing member 10 can be manufactured in the following manner. Firstly, the plating foundation layers 18 having a predetermined pattern are formed on the base layer 12. Then, plating is performed on the formed plating foundation layers 18, and the metal layers 14 having a predetermined pattern are formed.

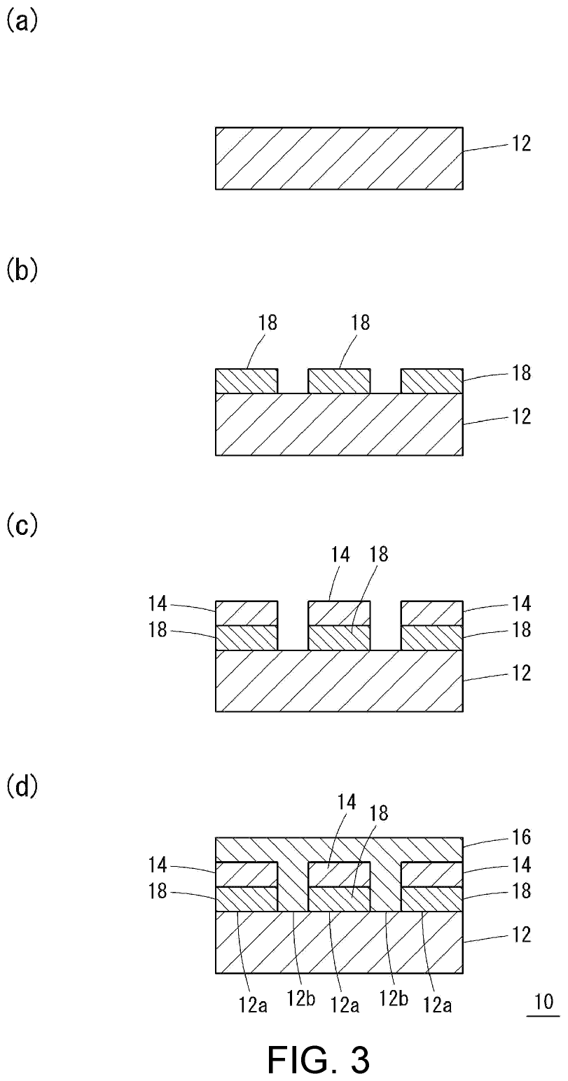

Firstly, as shown in (a) of FIG. 3, the base layer 12 is prepared. The base layer 12 can be formed using a material for forming a base layer containing an organic polymer. When the base layer 12 has a tubular shape (belt shape), the outer peripheral surface of a cylindrical or columnar mold is coated with the material for forming a base layer (coating material), and a drying treatment is performed. If necessary, a heat treatment may be performed. The coating method may be, for example, a dip coat method, a dispenser coat method (nozzle coat method), a roll coat method, a ring coat method, and the like. When the base layer 12 has a roll shape, the material for forming a base layer (kneaded product) is injected into a roll-molding mold, and a heat treatment is performed. Alternatively, the material for forming a base layer (kneaded product) is extrusion-molded.

Next, as shown in (b) of FIG. 3, the plating foundation layers 18 having a predetermined pattern are formed on the base layer 12. The plating foundation layers 18 can be formed by screen printing using a material for forming a foundation (coating material) containing a plating catalyst and a binder. If necessary, a drying treatment and a heat treatment may be performed. In addition, a degreasing treatment, a cleaning treatment, and the like may be performed after the screen printing. The plating foundation layers 18 are coating films containing a plating catalyst and a binder.

It is sufficient if the plating catalyst has catalytic power which is necessary for performing plating on the plating foundation layers 18. This catalyst metal may be: a Pt group metal such as Pd, Pt, or the like; Ag; Au; an alloy of these metals; and the like. As the catalyst metal for performing plating, these metals may be used alone, or two or more kinds of the metals may be used in combination. Among these metals, Pd, Pt, Ag, and an alloy of these metals are more preferable from the viewpoint of excellent catalytic power and the like. In addition, Pd is particularly preferable.

The binder may be polyimide, polyamide-imide, modified polyamide-imide, modified polyimide, polyether sulfone, a fluorine resin, polycarbonate, and the like.

In the material for forming a foundation (coating material), from the viewpoint of plating efficiency and the like, the solid content concentration of the plating catalyst is preferably 0.1 mass % or more. The solid content concentration of the plating catalyst is more preferably 0.5 mass % or more. In addition, from the viewpoint of dispersibility of the plating catalyst, adhesion of the metal layers 14, and the like, the solid content concentration of the plating catalyst is preferably 10.0 mass % or less. The solid content concentration of the plating catalyst is more preferably 6.0 mass % or less.

The thickness of the plating foundation layer 18 is not particularly limited, but from the viewpoint of, for example, adhesion and uniformity of the base layer 12 and the metal layers 14, the thickness of the plating foundation layer 18 is preferably 0.05 μm or more. The thickness of the plating foundation layer 18 is more preferably 0.1 μm or more, and further preferably 0.3 μm or more. In addition, from the viewpoint of economic efficiency and the like, the thickness of the plating foundation layer 18 is preferably 10 μm or less. The thickness of the plating foundation layer 18 is more preferably 5.0 μm or less, and further preferably 3.0 μm or less.

Next, as shown in (c) of FIG. 3, plating is performed, and the metal layers 14 are formed on the plating foundation layers 18. The metal layers 14 can be formed by electroless metal plating. The electroless metal plating is performed using a plating liquid. If necessary, cleaning may be performed by water or the like after the plating.

A metal ion, a reducing agent, a complexing agent, a pH buffer, and the like are contained in the plating liquid. The metal ion is an ion of a plating metal. The plating metal may be Cu, Ni, Ag, Pd, Sn, Au, an alloy of these metals, and the like. Among these metals, Cu, Ni, Ag, and an alloy of these metals are more preferable from the viewpoint of excellent adhesion with the plating foundation and the like. In addition, Ni and a Ni alloy are particularly preferable from the viewpoint of catalyst activity with respect to the catalyst metal of the plating foundation, adhesion with the plating foundation, and the like.

The reducing agent may be a hypophosphorous acid, hypophosphite, dimethylamine borane, hydrazine, and the like. Among these reducing agents, a hypophosphorous acid and hypophosphite are preferable from the viewpoint of stability of the plating liquid and the like. The pH buffer may be a lactic acid, an acetic acid, a succinic acid, and the like.

The complexing agent may be a carboxylic acid or an amine compound. The complexing agent may use only the carboxylic acid, may be only the amine compound, or may be a combination of the carboxylic acid and the amine compound. The carboxylic acid may be a citric acid, a malic acid, a tartaric acid, an ethylenediaminetetraacetic acid (EDTA), and the like. The amine compound may be glycine, alanine, ethylenediamine, propanediamine, and the like.

Furthermore, a surfactant can also be blended into the plating liquid. The surfactant may be a cationic surfactant, an amphoteric surfactant, and the like.

The cationic surfactant may be, for example, a quaternary ammonium salt type surfactant such as lauryl trimethyl ammonium chloride, ethylene oxide addition type ammonium chloride, and the like. These cationic surfactants may be used alone or may be used in combination. In addition, the amphoteric surfactant may be, for example, a betaine type surfactant such as lauryl betaine, amidopropyl betaine, dimethyl alkyl betaine, and the like. These amphoteric surfactants may be used alone or may be used in combination. The blending amount of the cationic surfactant or the blending amount of the amphoteric surfactant is preferably within a range of 0.01 to 10 g/L.

Next, as shown in (d) of FIG. 3, on a surface of the base layer 12 on a side where the metal layers 14 are formed, a material for forming a protective layer fills on the metal layers 14 and between the metal layers 14 so as to continuously cover the surfaces 12b of the base layer 12 not covered with the metal layers 14 and the surfaces of the metal layers 14, the material for forming a protective layer is coated so that the outer side surface of the protective layer 16 becomes flush, and a drying treatment is performed. If necessary, a heat treatment may be performed. The coating method may be, for example, a dip coat method, a dispenser coat method (nozzle coat method), a roll coat method, a ring coat method, and the like.

The embodiment of the present disclosure is described above, but the present disclosure is not limited to the above-described embodiment at all, and various changes may be made without departing from the gist of the present disclosure.

For example, on the outer side of the protective layer 16 of the fixing member 10, one, two, or more covering layers may be formed so as to cover the protective layer 16 over the entire circumference. The covering layer can be formed by, for example, an insulation material, a rubber elastic material, a fluorine resin material, and the like.

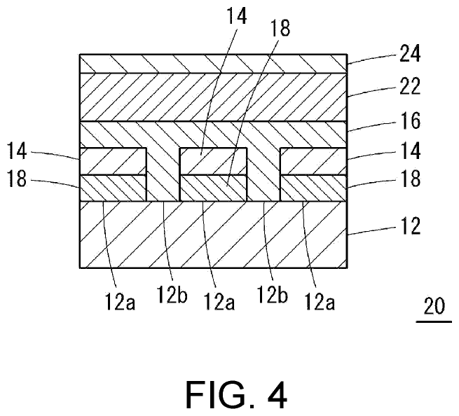

In FIG. 4, a fixing member 20 according to another embodiment is shown. The fixing member 20 is formed in a cylindrical shape and has a seamless structure having no joint in the circumferential direction. The fixing member 20 includes: the base layer 12, the metal layer 14 formed on the base layer 12, the protective layer 16 formed on the metal layer 14, an elastic body layer 22 formed on the protective layer 16, and a surface layer 24 formed on the elastic body layer 22.

The fixing member 20 is different from the fixing member 10 only in that the fixing member 20 includes the elastic body layer 22 and the surface layer 24 on the protective layer 16, other configurations of the fixing member 20 are the same as those of the fixing member 10, and descriptions of the same configurations are omitted.

The elastic body layer 22 is configured by an elastic material such as a rubber material or the like. The elastic material may be silicone rubber, fluorine rubber, and the like. The elastic body layer 22 can be formed by coating, as the coating material, the elastic material such as the rubber material or the like onto the protective layer 16. The thickness of the elastic body layer 22 is not particularly limited as long as the thickness is within a range of 120 to 450 μm.

The surface layer 24 may be configured by a material having high releasability with respect to a toner. The material of the surface layer 24 may be a polymer used for a surface layer such as a fluorine resin, a fluorine rubber, and the like. The surface layer 24 can be formed by covering the outer side of the elastic body layer 22 with the material of the surface layer 24 which is molded in a tubular shape. The thickness of the surface layer 24 is not particularly limited as long as the thickness is within a range of 3 to 50 μm.

In addition, in the above-described embodiment, it is illustrated that the plating foundation layers 18 are coating films containing a plating catalyst and a binder, but the plating foundation layers 18 may be formed by a conventional method in which a catalyst is applied on the base layer 12. Specifically, the plating foundation layers 18 may be formed in a way that after a catalyst for electroless plating is adsorbed on the surface of the base layer 12, a reduction treatment is performed, and a catalyst metal for electroless plating is generated on the base layer 12. Preferably, in order that the catalyst for electroless plating is adsorbed on the surface of the base layer 12, surface activation of the base layer 12 is performed. For example, a hydrophilic group such as a hydroxyl group, a carboxyl group, and the like may be generated on the surface of the base layer 12, and the catalyst for electroless plating may be applied on the surface of the base layer 12. The hydrophilic group of the base layer 12 can be relatively easily formed by hydrolysis using an alkali treatment. The reduction treatment may use a method (alkali catalyst method) in which after being brought contact with a metal ion-water soluble polymer complex solution such as a Pd ion-water soluble polymer complex solution, the metal ion is reduced by a reducing agent containing dimethylamine borane, sodium borohydride, and the like, the water-soluble polymer is removed, and a metal is deposited. Alternatively, the reduction treatment may use other methods. In addition, a sensitizer-activator method, a catalyst-accelerator method, or the like using reducing power of a tin ion may be used.

### EXAMPLE

Hereinafter, the present disclosure is described in detail using examples and comparative examples.

<Material for Forming Base Layer>
PI: “U-Imide AR” manufactured by Unitika (polyimide)

<Material for Forming Protective Layer>
PI: “U-Imide AR” manufactured by Unitika (polyimide)
PAI: “Pyromax HR-16NN” manufactured by Toyobo Co., Ltd. (polyamide-imide)
PA: “Torejin EF-30” manufactured by Toray Industries (polyamide)

<Material for Forming Plating Foundation>

A material for forming a plating foundation containing Pd was used.

<Degreasing liquid>

A degreasing liquid was prepared by mixing 200 ml of an alkaline degreasing agent (“OPC-190 cleaner” manufactured by Okuno Chemical Industries Co., Ltd.), 1200 ml of caustic soda of 3 mass %, and 600 ml of ion-exchange water.

<Conditioner Liquid>

50 ml/L of a cationic surface conditioner (“CONDIRIZER FR CONC” manufactured by Okuno Chemical Industries Co., Ltd.) was used as the conditioner liquid.

<Electroless Metal Plating Liquid>

An electroless metal plating liquid was prepared by mixing 26 g/L of nickel sulfate hexahydrate, 32 g/L of sodium hypophosphite monohydrate (reducing agent), and 30 g/L of sodium citrate dihydrate (complexing agent).

### Examples 1 to 14

<Manufacture of Base Layer>

A surface of a cylindrical pipe which is made of aluminium and has a diameter of 30 mm and an axial length of 450 mm was coated with the material for forming a base layer by a dip coat method, and dried at 230° C. for 60 minutes. Thereafter, a heat treatment was performed at 350° C. for 30 minutes. Moreover, a pull-up speed during the above-described coating was set to 100 mm/sec. Thereby, a tubular base layer (having a thickness of 50 μm) was formed on the outer peripheral surface of the cylindrical pipe.

<Manufacture of Plating Foundation Layer and Metal Layer>

The material for forming a plating foundation was patterning-coated on a surface of the formed base layer in a linear shape by screen printing, a heat treatment was performed at 120° C. for 15 minutes, and then a heat treatment was further performed at 240° C. for 15 minutes. Thereby, a plating foundation layer (with a thickness of 0.5 μm) having a predetermined pattern is formed on the base layer. Thereafter, immersion in the degreasing liquid was performed at 65° C. for 5 minutes, and then washing was performed by rinsing with pure water. Thereafter, immersion in the electroless metal plating liquid (plating liquid temperature: 84° C.) was performed, and then washing was performed by rinsing with pure water. Thereby, a metal layer (nickel plating) which was patterned in a linear shape was formed on the plating foundation layer. The plating foundation layer and the metal layer form a ring shape with a predetermined line width along a circumferential direction of the above-described base layer, and a plurality of the plating foundation layers and the metal layers which have a ring shape are disposed at predetermined intervals in an axial direction of the above-described base layer. In Example 1, the line width of the plating foundation layer was set to 1 mm, and the interval of the plating foundation layers was adjusted so that the contact area ratio between the protective layer and the base layer became a predetermined value. In each example and each comparative example, the number of the plating foundation layers to be formed was set to be the same, and the line width of the plating foundation layer in other examples and comparative examples was adjusted so that the contact area ratio between the protective layer and the base layer became a predetermined value. In addition, the thickness of the metal layer was adjusted by plating time.

<Manufacture of Protective Layer>

On the surface of the formed base layer on a side where the metal layers are formed, the material for forming a protective layer filled on the metal layers and between the metal layers so as to continuously cover the surfaces of the base layer not covered with the metal layers and the surfaces of the metal layers, and the material for forming a protective layer was coated so that the outer side surface of the protective layer became flush as shown in (b) of FIG. 2. Thereafter, a heat treatment was performed in predetermined heat treatment conditions. Thereby, a protective layer was formed on the base layer. The thickness of the protective layer on the metal layers was adjusted by the coating amount of the material for forming a protective layer. According to the above description, a fixing member for an electrophotographic device having a base layer, metal layers, and a protective layer was manufactured.

(Heat Treatment Conditions)
PI: 80° C.×30 min+120° C.×30 min+200° C.×30 min+350° C.×30 min
PAI: 230° C.×60 min
PA: 130° C.×30 min

### Comparative Example 1

Except that no protective layer was formed, a fixing member for an electrophotographic device having a base layer and metal layers was manufactured in the same way as in Example 1.

### Comparative Example 2

Except that the entire outer peripheral surface of the base layer was coated with the material for forming a plating foundation without performing screen printing, a fixing member for an electrophotographic device having a metal layer on the entire outer peripheral surface of the base layer was manufactured in the same way as in Example 1.

### Comparative Example 3

Except that a material for forming a protective layer was nylon (polyamide), a fixing member for an electrophotographic device having a base layer, metal layers, and a protective layer was manufactured in the same way as in Example 1.

Each of the manufactured fixing members for an electrophotographic device was used, and the following durability evaluation, adhesion evaluation, heat-generating property evaluation were performed. The results of the evaluations are shown in Table 1.

<Durability>

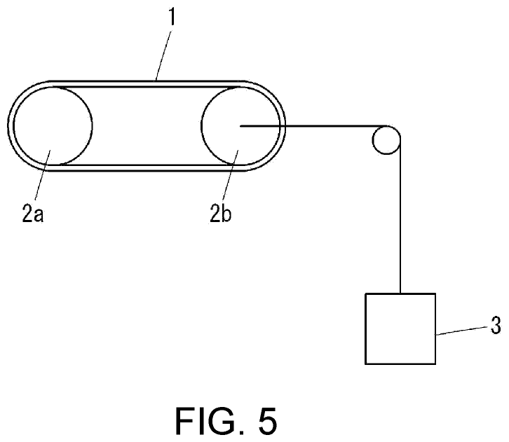

As shown in FIG. 5, a load 3 (1 kg) was applied and Sample 1 was pulled by two shafts, rotation shafts (ϕ6) 2a and 2b were rotated at 1000 rpm, and a tensile endurance test of Sample 1 was performed. Endurance time was set to 2 hours. A case in which no crack was generated in the metal layer at all was recorded as “⊚”. A case in which a crack was generated in the metal layer and the number of the generated crack was 1 or more and 3 or less was recorded as “∘”, a case in which the number of the generated crack was 4 or more and 6 or less was recorded as “Δ”, and a case in which the number of the generated crack was 7 or more was recorded as “x”.

<Adhesion>

After the manufactured fixing member was left at 200° C. for 1 hour, a crosscut test was performed on the fixing member based on JIS-K5600-5-6. Crosscut of 1 mm×1 mm (total number of mass: 25 masses) was performed in a way that a blade reaches the base layer from the protective layer side of the fixing member, and a peel test of a tape was performed. A PTFE tape (P-422) manufactured by Nitto Denko was used as the tape. A case in which the metal layer did not peel off from the base layer at all was recorded as “⊚”. A case in which the metal layer peeled off from the base layer and the number of the mass that peeled off was 1 mass or more and 5 masses or less was recorded as “0”, a case in which the number of the mass that peeled off was 6 masses or more and 9 masses or less was recorded as “A”, and a case in which the number of the mass that peeled off was 10 masses or more was recorded as “x”.

<Heat-Generating Properties>

The manufactured fixing member was used to measure the time until the surface temperature of the fixing member on the protective layer side reached 100° C. by IH temperature rise (in the vicinity of the IH coil). A case in which the reach time was less than 5 seconds was recorded as “⊚”, a case in which the reach time was 5 seconds or more and less than 10 seconds was recorded as “0”, a case in which the reach time was 10 seconds or more and less than 15 seconds was recorded as “Δ”, and a case in which the reach time was 15 seconds or more was recorded as “x”.

TABLE 1

| | | | | | | | | | | | | | | | | | Comparative | |
|---|---|---|---|---|---|---|---|---|---|---|---|---|---|---|---|---|---|---|
| | | Example | | | | | | | | | | | | | | | Example | |
| | | 1 | 2 | 3 | 4 | 5 | 6 | 7 | 8 | 9 | 10 | 11 | 12 | 13 | 14 | 1 | 2 | 3 |
| Protective | Material | PI | PI | PI | PI | PI | PI | PI | PI | PI | PI | PI | PI | PI | PAI | — | PI | PA |
| layer | Thickness on | 20 | 5.0 | 10 | 50 | 60 | 20 | 20 | 20 | 20 | 20 | 20 | 20 | 20 | 20 | — | 20 | 20 |
| | metal layer (μm) | | | | | | | | | | | | | | | | | |
| | Contact area ratio | 40 | 40 | 40 | 40 | 40 | 14 | 20 | 75 | 80 | 40 | 40 | 40 | 40 | 40 | — | 0 | 40 |
| | with base layer | | | | | | | | | | | | | | | | | |
| | (%) | | | | | | | | | | | | | | | | | |
| Metal | Thickness (μm) | 5.0 | 5.0 | 5.0 | 5.0 | 5.0 | 5.0 | 5.0 | 5.0 | 5.0 | 0.5 | 1.0 | 10 | 15 | 5.0 | 5.0 | 5.0 | 5.0 |
| layer | | | | | | | | | | | | | | | | | | |
| Base layer | Material | PI | PI | PI | PI | PI | PI | PI | PI | PI | PI | PI | PI | PI | PI | PI | PI | PI |
| Evaluation | Durability | ⊚ | Δ | ◯ | ⊚ | ⊚ | Δ | ◯ | ◯ | Δ | Δ | ◯ | ◯ | Δ | Δ | X | Δ | Δ |
| | Adhesion | ⊚ | Δ | ◯ | ⊚ | ⊚ | Δ | ◯ | ⊚ | ⊚ | ⊚ | ⊚ | ⊚ | ⊚ | Δ | X | X | X |
| | Heat-generating | ⊚ | ⊚ | ⊚ | ◯ | Δ | ⊚ | ⊚ | ◯ | Δ | Δ | ◯ | ⊚ | ⊚ | ⊚ | ⊚ | ⊚ | ⊚ |
| | properties | | | | | | | | | | | | | | | | | |

In the fixing member of Comparative example 1, no protective layer is arranged on the metal layer. Therefore, in the durability test, many cracks are generated in the metal layer due to repeated bending fatigue. In addition, adhesion of the metal layer is poor. The fixing member of Comparative example 2 has the metal layer on the entire surface of the base layer, and has no surface not covered with the metal layer on the base layer. Therefore, even if the protective layer is formed on the metal layer, the protective layer and the base layer are not bonded to each other, and thus the adhesion improvement effect of the metal layer brought by the protective layer is poor, and adhesion of the metal layer is poor. In the fixing member of Comparative example 3, with respect to the base layer made of polyimide, the protective layer is made of polyimide, and the protective layer does not contain a resin that includes an imide bond in a repeating unit, and thus bondability between the base layer and the protective layer is poor, the adhesion improvement effect of the metal layer brought by the protective layer is poor, and adhesion of the metal layer is poor.

In contrast, with regard to the fixing members of the examples, the protective layer continuously covers the surfaces of the base layer not covered with the metal layers and the surfaces of the metal layers, and the metal layers are embedded between the base layer and the protective layer. Thus, the generation of crack in the metal layers due to repeated bending fatigue is suppressed, and durability is excellent. In addition, the base layer and the protective layer respectively contain a resin that includes an imide bond in a repeating unit, and the protective layer is bonded to the base layer by the surfaces of the base layer not covered with the metal layers. Thus, the adhesion improvement effect of the metal layer brought by the protective layer is excellent, and adhesion of the metal layer is excellent.

Besides, comparing Examples 1 to 5, durability and adhesion are more excellent when the thickness of the protective layer is 10 μm or more, and durability and adhesion are further excellent when the thickness of the protective layer is 15 μm or more. In addition, heat-generating properties are more excellent when the thickness of the protective layer is 50 μm or less, and heat-generating properties are further excellent when the thickness of the protective layer is 30 μm or less. Besides, comparing Example 1 and Examples 6 to 9, adhesion is more excellent when the area ratio of the surface to which the protective layer is bonded with respect to the base layer is 20% or more, and adhesion is further excellent when the area ratio is 30% or more. Besides, durability is more excellent when the area ratio is 20% or more and 75% or less. When the area ratio is increased, adhesion between the base layer and the protective layer is improved, and thus durability is improved. On the other hand, when the area ratio is increased, the metal layer becomes thinner (line width is reduced), thus resulting in a decrease in durability. Therefore, the result is that durability is more excellent when the area ratio of the surface to which the protective layer is bonded with respect to the base layer is 75% than that when the area ratio is 80%. Besides, heat-generating properties are also more excellent when the area ratio is 75% or less. Besides, comparing Example 1 and Examples 10 to 13, durability and heat-generating properties are more excellent when the thickness of the metal layer is within a range of 1.0 to 10 μm.

The examples of the present disclosure are described above, but the present disclosure is not limited to above-described examples at all, and various changes may be made without departing from the gist of the present disclosure.

What is claimed is:

1. A fixing member for an electrophotographic device, comprising: a base layer, a metal layer formed on the based layer, a protective layer formed on the metal layers, and a plating foundation layer formed under the metal layer and on the base layer, wherein
the metal layer is configured to form a predetermined pattern, the base layer comprises a surface which is covered with the metal layer and a surface which is not covered with the metal layer,
the protective layer continuously covers the surface of the base layer not covered with the metal layer and a surface of the metal layer, and is bonded to the surface of the base layer not covered with the metal layer, and
the base layer and the protective layer contain a resin that comprises an imide bond in a repeating unit, and
the plating foundation layer comprises a plating catalyst and a binder, wherein the binder comprises at least one selected from polyimide, polyamide-imide, modified polyamide-imide, modified polyimide, polyether sulfone, a fluorine resin, and polycarbonate.

2. The fixing member for an electrophotographic device according to claim 1, wherein the resin that comprises an imide bond in the repeating unit is a polyimide resin.

3. The fixing member for an electrophotographic device according to claim 1, wherein a thickness of the metal layer is within a range of 1.0 to 10 μm.

4. The fixing member for an electrophotographic device according to claim 1, wherein an area ratio of the surface to which the protective layer is bonded with respect to the entire surface of the base layer is within a range of 20 to 75%.

5. The fixing member for an electrophotographic device according to claim 1, wherein a thickness of the protective layer on the metal layer is within a range of 10 to 50 μm.

6. The fixing member for an electrophotographic device according to claim 1, wherein the plating foundation layer is formed in the same pattern shape as the metal layer.

7. The fixing member for an electrophotographic device according to claim 1, wherein the protective layer comprises a heat-conductive filler.

8. The fixing member for an electrophotographic device according to claim 1, wherein the predetermined pattern of the metal layer is a ring shape along the circumferential direction of the fixing member for an electrophotographic device having a cylindrical shape.
